(19) United States
(12) Patent Application Publication
(10) Pub. No.: US 2026/0099145 A1
(43) Pub. Date: Apr. 9, 2026

(54) VEHICULAR DRIVING ASSIST SYSTEM UTILIZING SEQUENTIAL SENSOR FUSION

(71) Applicant: Magna Electronics Inc., Auburn Hills, MI (US)

(72) Inventors: Wajahat Abbas Khan, Hattersheim (DE); Pavel Kyshtymov, Gelnhausen (DE); Roaldje Nadjiasngar, Sulzbach Am Main (DE)

(21) Appl. No.: 19/346,908

(22) Filed: Oct. 1, 2025

Related U.S. Application Data
(60) Provisional application No. 63/703,303, filed on Oct. 4, 2024.

(51) Int. Cl. G05D 1/242; G05D 111/30; G05D 111/67; H04W 4/38

(52) U.S. Cl. CPC G05D 1/242; H04W 4/38; G05D 2111/30; G05D 2111/67

(57) ABSTRACT

A vehicular sensing system includes a radar sensor disposed at a vehicle and operable to capture sensor data. The vehicular sensing system, based on processing of captured sensor data, sorts captured sensor data by chronological order and generates an object list listing one or more objects sensed by the radar sensor. The system converts the object list from sensor-level coordinates into global coordinates. The radar sensor, after the object list is converted from sensor-level coordinates into global coordinates, captures additional sensor data. The system, based on processing at the ECU of captured additional sensor data, converts the object list from global coordinates into sensor-level coordinates. The system, after the object list is converted from global coordinates to sensor-level coordinates, and via processing at the ECU of the additional sensor data, updates the object list.

### CROSS REFERENCE TO RELATED APPLICATION

The present application claims the filing benefits of U.S. provisional application Ser. No. 63/703,303, filed Oct. 4, 2024, which is hereby incorporated herein by reference in its entirety.

### FIELD OF THE INVENTION

The present invention relates generally to a vehicular driving assist system for a vehicle and, more particularly, to a vehicular driving assist system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular sensing system includes a radar sensor disposed at a vehicle equipped with the vehicular sensing system. The radar sensor is operable to capture sensor data. An electronic control unit (ECU) includes electronic circuitry and associated software. Sensor data captured by the radar sensor is transferred to the ECU. The electronic circuitry of the ECU includes a data processor for processing sensor data captured by the radar sensor and transferred to the ECU. The vehicular sensing system, based at least in part on processing at the ECU of sensor data captured by the radar sensor, sorts sensor data captured by the radar sensor by chronological order based on when the sensor data was captured by the radar sensor and generates an object list listing one or more objects sensed via processing at the ECU of sensor data captured by the radar sensor. The vehicular sensing system converts the object list from sensor-level coordinates into global coordinates. The radar sensor, after the object list is converted from sensor-level coordinates into global coordinates, captures additional sensor data. The vehicular sensing system, based at least in part on processing at the ECU of additional sensor data captured by the radar sensor, converts the object list from global coordinates into sensor-level coordinates. The vehicular sensing system, after the object list is converted from global coordinates into sensor-level coordinates and via processing at the ECU of the additional sensor data captured by the radar sensor, updates the object list based on the additional sensor data captured by the radar sensor.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIG. 2 is a diagram of an example representation of a track-to-track fusion architecture;

FIG. 3 is a diagram of an example representation of a measurement-to-track fusion architecture;

FIG. 4 is a diagram of an example representation of a sequential measurement-to-track fusion architecture;

FIG. 5 is a diagram of an example representation of a sequential nonlinear measurement-to-track fusion architecture; and

FIG. 6 is a block diagram of the sequential nonlinear measurement-to-track fusion architecture of FIG. 5.

### DESCRIPTION OF THE PREFERRED EMBODIMENTS

A vehicle sensing system and/or driver assist system and/or driving assist system and/or object detection system and/or alert system operates to capture sensing data exterior of the vehicle and may process the captured data to detect objects at or near the vehicle and in the predicted path of the vehicle, such as to assist a driver of the vehicle or a control for an autonomous vehicle in maneuvering the vehicle in a forward or rearward direction. The system includes a processor that is operable to receive sensing data from one or more sensors and provide an output, such as an alert or control of a vehicle system.

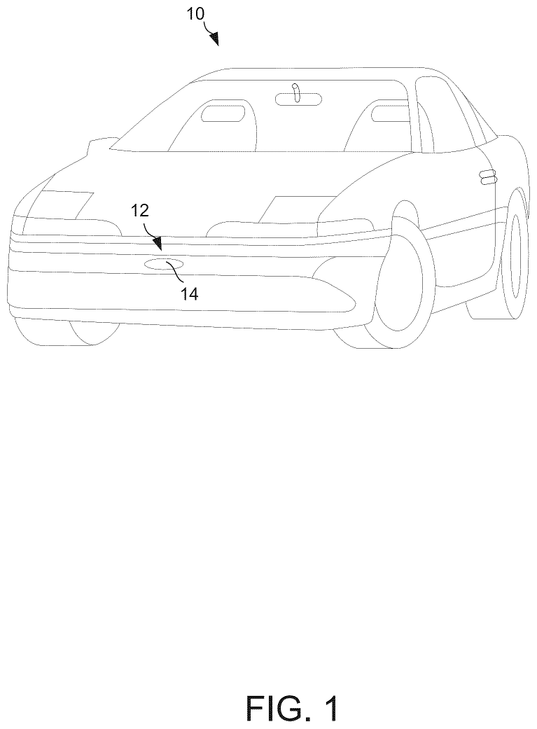

Referring now to the drawings and the illustrative embodiments depicted therein, a vehicle 10 (FIG. 1) includes a driving assistance system or sensing system 12 that includes at least one radar sensor unit, such as a forward facing radar sensor unit 14 (and the system may optionally include multiple exterior facing sensors, such as cameras, radar, or other sensors, such as a rearward facing sensor at the rear of the vehicle, one or more corner sensing sensors such as corner-mounted radar sensors, and/or a sideward/rearward facing sensor at respective sides of the vehicle), which sense regions exterior of the vehicle. The sensing system 12 includes a control or electronic control unit (ECU) that includes a data processor that is operable to process data captured by the radar sensor(s) and/or the other sensors (e.g., one or more cameras). The sensing system may also include a radar sensor that includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle (e.g., an advanced driving assist system (ADAS)), with the driving assist system controlling at least one function or feature of the vehicle (such as to provide autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

Sensor fusion is an approach for processing sensor data from a plurality of sensors (e.g., by fusing image data captured by a camera and radar data captured by a radar sensor). Implementations of sensor fusion, i.e., fusion architectures, may include track-to-track fusion, measurement-to-track fusion, sequential measurement-to-track fusion, and sequential nonlinear measurement-to-track fusion. A fusion architecture ideally optimizes use of the plurality of sensors of the equipped vehicle 10 without performance degradation due to time-misalignment among the plurality of sensors.

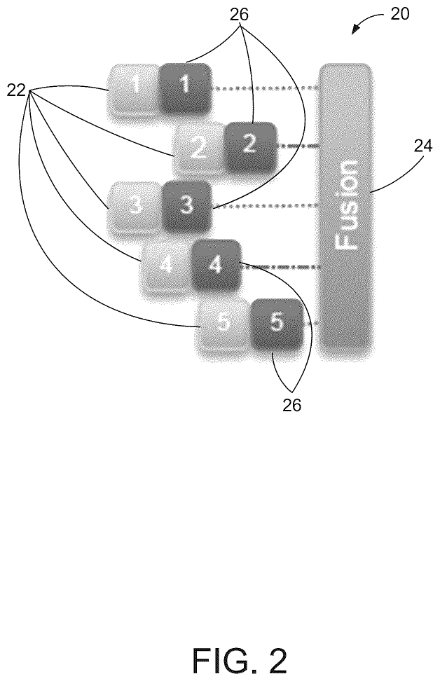

FIG. 2 illustrates an example representation of a track-to-track fusion architecture 20. The track-to-track fusion architecture 20 combines sensor data (i.e., sensor measurements or sensor outputs) of a plurality of sensors 22 (e.g., radar sensors, cameras, etc.) at object levels into a single object list. For example, a fusion system 24 may combine local sensor object lists of a plurality of trackers 26, each tracker associated with a sensor of the plurality of sensors 22, into a single object list. Fusion system determinations made through the track-to-track fusion architecture 20 may be attribute based or information based. Local object validity determinations, i.e., object validity determinations made locally by each tracker of the plurality of trackers 26, may result in noise at the system level. Such noise may negatively affect system-level output, i.e., the output of the fusion system 24 or global output. That is, track-to-track fusion may experience common process noise issues.

When the output of one or more sensors of the sensors 22 lags the outputs of other sensors of the sensors 22, the track-to-track fusion architecture 20 may coast objects of the output of the one or more lagging sensors to synchronize the outputs of the sensors 22. For example, sensor data from the lagging sensor may be repeated or interpolated. Synchronization of outputs of the lagging sensor 22 includes establishing a common reference time frame to detect time differences among the outputs of the sensors 22. In other words, establishing the common reference time frame enables the track-to-track fusion architecture 20 to detect the one or more lagging sensors. The track-to-track fusion architecture 20 is scalable to any number of sensors with limited or modest increases in system requirements for the fusion architecture. Runtime of the track-to-track fusion architecture 20 may be faster than runtime of sensor-level object tracking.

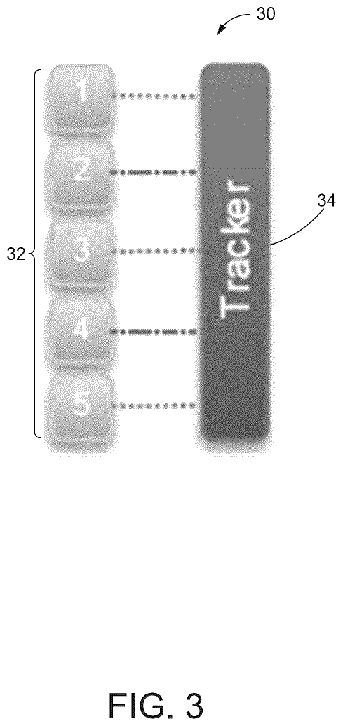

FIG. 3 illustrates an example representation of a measurement-to-track fusion architecture 30. The measurement-to-track fusion architecture 30 combines measurements from a plurality of sensors 32 into a single object list. A tracker 34 receives sensor measurements from a plurality of sensors 32, in which the sensor measurements are communicated to the tracker 34 in a singular system of coordinates common to the entire fusion architecture 30 and/or vehicular vision system (i.e., common coordinates or global coordinates or vehicle-level coordinates). The tracker 34 combines the sensor measurements of the plurality of sensors 32 into a single object list. Accordingly, the measurement-to-track fusion architecture 30 is generally incompatible with sensing systems that include a radar sensor, as Doppler measurements cannot be expressed in global coordinates with other sensors 32. The sensors 32 send measurements synchronously to provide sensor data in global coordinates. Scaling of the measurement-to-track fusion architecture 30 is limited by the size of data associated with the measurements from the sensors 32. Runtime complexity of the measurement-to-track fusion architecture 30 generally increases with the size of sensor data associated with the measurements from the plurality of sensors 32.

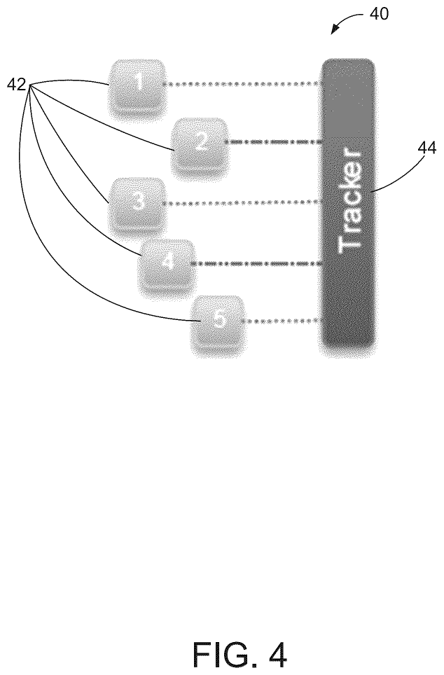

FIG. 4 illustrates an example representation of a sequential measurement-to-track fusion architecture 40. In the sequential measurement-to-track fusion architecture 40, each sensor of a plurality of sensors 42 sends measurements in a first-in-first-out (FIFO) protocol to a tracker 44. The tracker 44 converts the measurements from each sensor of the plurality of sensors 42 into global coordinates. Accordingly, the sequential measurement-to-track fusion architecture 40 is generally incompatible with sensing systems in which the sensors 42 include a radar sensor, as Doppler measurements cannot be expressed in global coordinates with other sensors 42. The measurements from the sensors 42 are asynchronous. The sequential measurement-to-track fusion architecture 40 uses a common reference time frame to sequence the asynchronous measurements from the sensors 42. The sequential measurement-to-track fusion architecture 40 is scalable to any number of sensors with limited or modest increases in system requirements for the fusion architecture. Runtime of the sequential measurement-to-track fusion architecture 40 scales linearly with the number of sensors 42 included in the system.

Each of the previously discussed architectures have useful applications when used within the constraints associated with the respective architecture. For example, track-to-track experiences common process noise and measurement-to-track/sequential measurement-to-track are generally incompatible with Doppler information. Accordingly, it is advantageous for a fusion architecture to allow an optimal use of all sensor measurements while also being tolerant to time-misalignment among sensors.

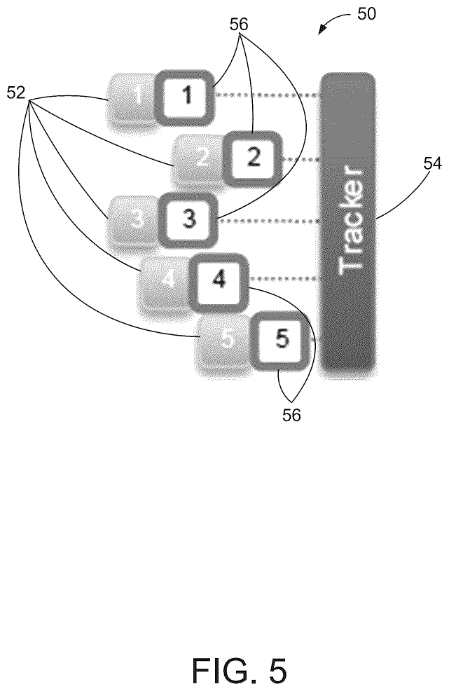

To this end, FIG. 5 illustrates an example representation of a sequential nonlinear measurement-to-track fusion architecture 50. In the sequential nonlinear measurement-to-track fusion architecture 50, a plurality of sensors 52 send or transmit measurements in sensor-level coordinates (i.e., local coordinates or local sensor coordinates) to a nonlinear tracker 54 using a FIFO protocol. In some examples, the sensors 52 associated with the sequential nonlinear measurement-to-track fusion architecture 50 may include one or more radar sensors, cameras, lidar sensors, ultrasonic sensors, and/or any combination thereof. The nonlinear tracker 54 includes, uses, and/or is a component of a sequencer 56, as discussed further below. The nonlinear tracker 54 converts the measurements from sensor-level coordinates into global coordinates to maintain a global object list.

The nonlinear tracker 54 converts the global object list back into sensor-level coordinates each time the nonlinear tracker 54 scans the sensors 52 for new sensor measurements (i.e., tracking updates). Accordingly, the nonlinear tracker 54 can process Doppler measurements taken by a radar sensor without limiting fusion architecture performance when the sensors 52 includes a radar sensor. For example, the sequential nonlinear measurement-to-track fusion architecture 50 can use Doppler information of a radar sensor of the sensors 52 as it would if the radar sensor was the only sensor 52 of a vision system of an equipped vehicle.

The measurements from the sensors 52 are asynchronous. The sequential nonlinear measurement-to-track fusion architecture 50 uses a common reference time frame to sequence the asynchronous measurements from the sensors 52. That is, the sequencer 56 uses the common reference time frame to sort and send the sensor measurements to the tracker 54. The sequential nonlinear measurement-to-track fusion architecture 50 is scalable to any number of sensors with limited or modest increase in system requirements for the fusion architecture. Runtime of the sequential nonlinear measurement-to-track fusion architecture 50 scales linearly with the number of sensors of the plurality of sensors 52.

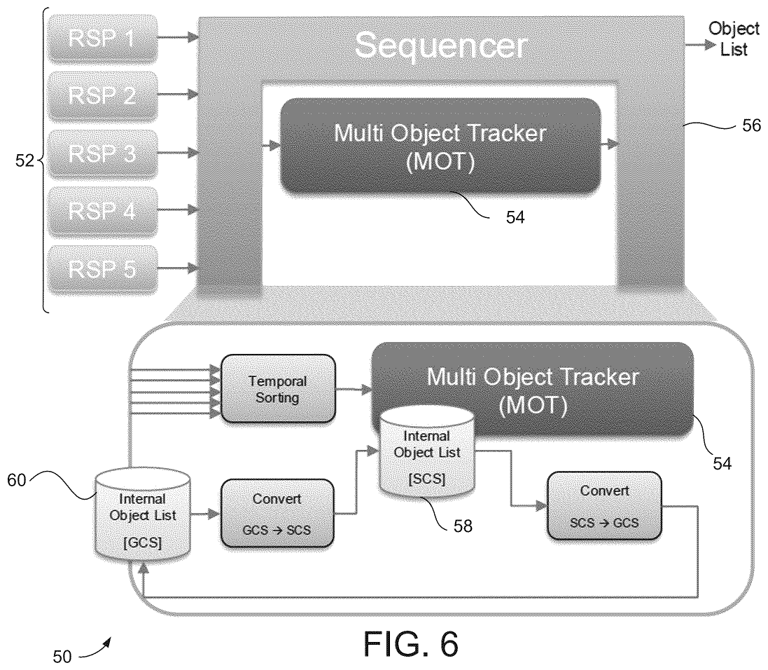

FIG. 6 is an example block diagram of the sequential non-linear measurement-to-track fusion architecture 50. The sequential nonlinear measurement-to-track fusion architecture 50 includes sequential multi-sensor multi-object tracking. In some examples, the sequencer 56 receives measurements from one or more sensors 52. The sequencer 56 includes a Multi-Object Tracker (MOT) 54 to maintain a global object list for the entire 360-degree surroundings of an equipped vehicle. In other words, the global object list encompasses sensor data collected from all of the sensors 52 on the equipped vehicle. The sequencer 56 outputs the global object list to the vision system of the equipped vehicle. Optionally, the sequencer 56 may output the global object list to any system or feature of the equipped vehicle. For example, the sequencer 56 may output the global object list to a sensing system, a driving assist system, an object detection system, an alert system, etc.

The sensors 52 may send measurements expressed in sensor-level coordinates to the sequencer 56. The sequencer 56 sorts the sensor measurements based on scan time of the sensor measurements. For example, the sequencer 56 may sort sensor measurements in ascending order based on a timestamp associated with each measurement of the sensor measurements.

The MOT 54 receives the sorted sensor data from the sequencer 56 according to a FIFO protocol. The MOT 54 records the sorted sensor data in a first internal object list 58, such that the first internal object list 58 contains the sorted sensor data in sensor-level coordinates. The MOT 54 converts the sorted sensor data and covariances (i.e., differences between each measurement from a given sensor 52 of the plurality of sensors 52) from sensor-level coordinates to global coordinates. The MOT 54 records the converted sensor data and covariances in a second internal object list 60. That is, the second internal object list 60 contains the sorted sensor data and covariances in global coordinates. Accordingly, the second internal object list 60 represents the global object list. With radar configuration information regarding a radar of the equipped vehicle, the MOT 54 may convert object states and covariances contained in the sensor data of the second internal object list 60 back into sensor-level coordinates. Maintaining a first object list in sensor-level coordinates and a second object list in global coordinates may reduce processing time of the MOT 54, as the MOT 54 may convert coordinates of a portion of either of the first object list 58 or the second object list 60 as needed to update the second object list 60 with newly captured sensor data. Similarly, maintaining the two object lists 58, 60 may reduce risk of data corruption or errors in converting the sensor data between sensor-level and global coordinates by obviating the need for converting an entire object list between sensor-level and global coordinates.

The sequencer 56 may output the global object list to any system or feature of the equipped vehicle. Optionally, the second internal object list 60 is the same as the first internal object list 58 but converted from sensor-level coordinates to global coordinates. That is, in some examples, the system only maintains a single object list and simply converts the single object lists between the two coordinate systems as needed for sensor data updates and use of the object list. Maintaining a single object list may reduce the size of memory required to store the captured sensor data at the MOT 54.

In some examples, the MOT 54 may convert the sorted sensor data and covariances of the second internal object list 60 from global coordinates back into sensor-level coordinates. In other words, the MOT 54 may reproduce the first internal object list 58 from the second internal object list 60. For example, the MOT 54 may convert the second internal object list 60 back into sensor-level coordinates when the sequencer 56 receives a new measurement from a sensor 52 of the plurality of sensors 52.

In further examples, object states and covariances are maintained in global coordinates by the MOT 54 concurrently with the reproduction of the first internal object list 58. The MOT 54 receives new sorted sensor data and covariances from the sequencer 56. The new sorted sensor data includes new measurements in sensor-level coordinates captured by at least one sensor of the plurality of sensors 52, which are sorted by the sequencer 56 based on scan time. The MOT 54 updates the first internal object list 58 with the new sorted sensor data and repeats the conversion cycle as described above. Sequential multi-sensor multi-object tracking converts sensor data from sensor-level coordinates to global coordinates, and from global coordinates to sensor-level coordinates, based on an object's Cartesian state vector and corresponding state covariance.

Accordingly, sequential multi-sensor multi-object tracking allows non-converted measurements from each sensor of the plurality of sensors to be sent using FIFO protocol to a single nonlinear multi-object tracker. That is, the sequential non-linear measurement-to-track fusion architecture processes radar measurements sequentially in a FIFO manner using a nonlinear multi-object tracker operating in sensor coordinates. The sequential non-linear measurement-to-track architecture does not require conversion of sensor measurements to global coordinates before tracking, allowing effective use of Doppler information from each sensor. The architecture also supports asynchronous sensor measurements, requiring only a common reference time frame. This sequential process does not require synchronous measurements from sensors of the equipped vehicle. In other words, the sequential non-linear measurement-to-track architecture does not require synchronization across sensors of the equipped vehicle. Through a nonlinear filter update process, the sequential nonlinear measurement-to-track fusion architecture can process Doppler information from a plurality of radar sensors. Sequential fusion is optimal in part as it is mathematically equivalent to track fusion and does not require synchronization because the times of measurement are asynchronous between radars.

The sequential non-linear measurement-to-track architecture includes bidirectional coordinate conversion for track updates. The architecture maintains object states and covariances in global coordinates. The global coordinates are converted to local sensor coordinates for track updates. Then, the updated object states and covariances are converted back to global coordinates. This dynamic coordinate conversion enables local sensor-specific updates while maintaining a unified global object list, increasing tracking accuracy and robustness.

The sequential non-linear measurement-to-track architecture is robust against individual sensor failures. Failure of a single sensor does not inhibit operation of the multi-object tracker, enabling continued operation and functionality of the tracker when one or more sensors of the equipped vehicle fails. That is, if a sensor of the equipped vehicle fails, the failure will not affect the operation of the MOT while runtime is comparable to other architectures.

The sequential non-linear measurement-to-track architecture is scalable to any number of sensors with linear runtime complexity. The sequential multi-sensor multi-object tracking architecture may operate effectively with only a single sensor and may be scaled to as many sensors as needed, as the processing capacity of the fusion center is the only limit. The MOT processes sensor data as it would for a single sensor regardless of the number of sensors included in the system. Unlike systems that incur increased computational complexity with an increase in sensors, the sequential non-linear measurement-to-track architecture maintains runtime efficiency with an increase in sensors. The architecture can operate with just one sensor or many, as scalability and runtime efficiency are determined by fusion center capacity.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Optionally, the system may include one or more cameras disposed at the vehicle and viewing exterior of the vehicle. The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a radar sensor disposed at a vehicle equipped with the vehicular sensing system, wherein the radar sensor is operable to capture sensor data;
an electronic control unit (ECU) comprising electronic circuitry and associated software;
wherein sensor data captured by the radar sensor is transferred to the ECU;
wherein the electronic circuitry of the ECU comprises a data processor for processing sensor data captured by the radar sensor and transferred to the ECU;
wherein the vehicular sensing system, based at least in part on processing at the ECU of sensor data captured by the radar sensor, (i) sorts sensor data captured by the radar sensor by chronological order based on when the sensor data was captured by the radar sensor and (ii) generates an object list listing one or more objects sensed via processing at the ECU of sensor data captured by the radar sensor;
wherein the vehicular sensing system converts the object list from sensor-level coordinates into global coordinates;
wherein the radar sensor, after the object list is converted from sensor-level coordinates into global coordinates, captures additional sensor data;
wherein the vehicular sensing system, based at least in part on processing at the ECU of additional sensor data captured by the radar sensor, converts the object list from global coordinates into sensor-level coordinates; and
wherein the vehicular sensing system, after the object list is converted from global coordinates into sensor-level coordinates, and via processing at the ECU of additional sensor data captured by the radar sensor, updates the object list based on the additional sensor data captured by the radar sensor.

2. The vehicular sensing system of claim 1, wherein the vehicular sensing system stores the object list in sensor-level coordinates as a first object list and stores the object list in global coordinates as a second object list.

3. The vehicular sensing system of claim 1, wherein the vehicular sensing system sends the updated object list to a driving assist system of the equipped vehicle.

4. The vehicular sensing system of claim 3, wherein the driving assist system, based on the updated object list, controls at least one selected from the group consisting of (i) longitudinal control of the equipped vehicle and (ii) lateral control of the equipped vehicle.

5. The vehicular sensing system of claim 1, further comprising a camera disposed at the equipped vehicle, wherein the vehicular sensing system generates the object list based in part on processing at the ECU of image data captured by the camera.

6. The vehicular sensing system of claim 1, further comprising a plurality of sensors, and wherein each sensor of the plurality of sensors transfers respective captured sensor data to the ECU asynchronously.

7. The vehicular sensing system of claim 6, wherein the ECU processes sensor data captured by each sensor of the plurality of sensors and transferred to the ECU based on a first-in-first-out protocol.

8. The vehicular sensing system of claim 6, wherein the vehicular sensing system generates the object list based at least in part on processing at the ECU of sensor data captured by each sensor of the plurality of sensors.

9. The vehicular sensing system of claim 1, wherein the vehicular sensing system sorts sensor data captured by the radar sensor based on timestamps.

10. The vehicular sensing system of claim 1, wherein the object list comprises an object state and a covariance for each object in the object list.

11. The vehicular sensing system of claim 1, wherein the vehicular sensing system generates the object list via processing at the ECU of sensor data captured by the radar sensor that represents 360 degrees surrounding the equipped vehicle.

12. The vehicular sensing system of claim 1, wherein sensor data captured by the radar sensor comprises Doppler information.

13. A vehicular sensing system, the vehicular sensing system comprising:
a plurality of sensors disposed at a vehicle equipped with the vehicular sensing system, wherein each sensor of the plurality of sensors is operable to capture sensor data;
an electronic control unit (ECU) comprising electronic circuitry and associated software;
wherein sensor data captured by each sensor of the plurality of sensors is transferred to the ECU;
wherein the electronic circuitry of the ECU comprises a data processor for processing sensor data captured by the plurality of sensors and transferred to the ECU;
wherein the vehicular sensing system, based at least in part on processing at the ECU of sensor data captured by each sensor of the plurality of sensors, (i) sorts sensor data captured by the plurality of sensors by chronological order based on when the sensor data was captured by each respective sensor and (ii) generates an object list listing one or more objects sensed via processing at the ECU of sensor data captured by each sensor of the plurality of sensors;
wherein the object list comprises an object state and a covariance for each object in the object list;
wherein the vehicular sensing system converts the object list from sensor-level coordinates into global coordinates;
wherein a sensor of the plurality of sensors, after the object list is converted from sensor-level coordinates into global coordinates, captures additional sensor data;
wherein the vehicular sensing system, based at least in part on processing at the ECU of additional sensor data captured by the sensor, converts the object list from global coordinates into sensor-level coordinates; and
wherein the vehicular sensing system, after the object list is converted from global coordinates into sensor-level coordinates, and via processing at the ECU of additional sensor data captured by the sensor, updates the object list based on the additional sensor data captured by the sensor.

14. The vehicular sensing system of claim 13, wherein the ECU processes sensor data captured by each sensor of the plurality of sensors and transferred to the ECU based on a first-in-first-out protocol.

15. The vehicular sensing system of claim 13, wherein the vehicular sensing system sends the updated object list to a driving assist system of the equipped vehicle.

16. The vehicular sensing system of claim 15, wherein the driving assist system, based on the updated object list, controls at least one selected from the group consisting of (i) longitudinal control of the equipped vehicle and (ii) lateral control of the equipped vehicle.

17. The vehicular sensing system of claim 13, wherein the vehicular sensing system generates the object list via processing at the ECU of sensor data captured by each sensor of the plurality of sensors that represents 360 degrees surrounding the equipped vehicle.

18. A vehicular sensing system, the vehicular sensing system comprising:
a radar sensor disposed at a vehicle equipped with the vehicular sensing system, wherein the radar sensor is operable to capture sensor data;
a camera disposed at the equipped vehicle, wherein the camera is operable to capture image data;
wherein the camera comprises an imager, and wherein the imager comprises a CMOS imaging array having at least one million photosensors arranged in rows and columns;
an electronic control unit (ECU) comprising electronic circuitry and associated software;
wherein sensor data captured by the radar sensor and image data captured by the camera are transferred to the ECU based on first-in-first-out protocol;
wherein the electronic circuitry of the ECU comprises a data processor for processing (i) sensor data captured by the radar sensor and transferred to the ECU and (ii) image data captured by the camera and transferred to the ECU;
wherein the vehicular sensing system, based at least in part on processing at the ECU of (i) sensor data captured by the radar sensor and (ii) image data captured by the camera, (a) sorts sensor data captured by the radar sensor and image data captured by the camera by chronological order based on when the sensor data was captured by the radar sensor and the image data was captured by the camera and (b) generates an object list listing one or more objects sensed via processing at the ECU of sensor data captured by the radar sensor and image data captured by the camera;
wherein the vehicular sensing system converts the object list from sensor-level coordinates into global coordinates;
wherein the radar sensor, after the object list is converted from sensor-level coordinates into global coordinates, captures additional sensor data, and wherein the camera, after the object list is converted from sensor-level coordinates into global coordinates, captures additional image data;
wherein the vehicular sensing system, based at least in part on processing at the ECU of additional sensor data captured by the radar sensor and additional image data captured by the camera, converts the object list from global coordinates into sensor-level coordinates; and
wherein the vehicular sensing system, after the object list is converted from global coordinates into sensor-level coordinates, and via processing at the ECU of additional sensor data captured by the radar sensor and additional image data captured by the camera, updates the object list based on the additional sensor data captured by the radar sensor and the additional image data captured by the camera.

19. The vehicular sensing system of claim 18, wherein sensor data captured by the radar sensor comprises Doppler information.

20. The vehicular sensing system of claim 18, wherein the vehicular sensing system sorts sensor data captured by the radar sensor and image data captured by the camera based on timestamps.
